(19) United States
(12) Patent Application Publication
(10) Pub. No.: US 2017/0013651 A1
(43) Pub. Date: Jan. 12, 2017

(54) NAS Security And Handling Of Multiple Initial NAS Messages

(71) Applicant: MediaTek Singapore Pte. Ltd., Singapore (SG)

(72) Inventors: Matti Moisanen, Oulu (FI); Jaakko Sitomaniemi, Oulu (FI)

(21) Appl. No.: 15/273,636

(22) Filed: Sep. 22, 2016

(51) Int. Cl. H04W 76/02; H04W 72/04; H04W 24/04

(52) U.S. Cl. CPC H04W 76/021; H04W 24/04; H04W 72/042; H04W 88/02

(57) ABSTRACT

Various solutions to Non-Access Stratum (NAS) security and handling of multiple initial NAS messages with respect to a user equipment in mobile communications are described. A user equipment (UE) may transmit a first message regarding a first procedure to a mobile network element, and transmit a second message regarding a second procedure to the mobile network element. The UE may receive a reply from the mobile network element. In response to receiving the reply, the UE may perform one or more operations that result in the second procedure being continued and the first procedure being discontinued.

### TECHNICAL FIELD

The present disclosure is generally related to mobile communications and, more particularly, to Non-Access Stratum (NAS) security and handling of multiple initial NAS messages with respect to a user equipment in mobile communications.

### BACKGROUND

Unless otherwise indicated herein, approaches described in this section are not prior art to the claims listed below and are not admitted to be prior art by inclusion in this section.

In the 3^{rd} Generation Partnership Project (3GPP), the NAS includes a set of protocols in the Evolved Packet System (EPS). The NAS is used to convey non-radio signaling between a user equipment (UE) and a Mobility Management Entity (MME) for access in a Long Term Evolution (LTE)/Evolved UMTS Terrestrial Radio Access (E-UTRA) network. The EPS Mobility Management (EMM) protocol, as a part of NAS, includes procedures related to mobility over an E-UTRAN access, authentication and security. EMM-specific procedures are UE-initiated. These procedures define attach/detach (to/from the Evolved Packet Core (EPC)) mechanisms.

Under the EPS Mobility Management (EMM) protocol, when security protected NAS signaling is established the network shall accept only security protected messages from a UE and discard any unprotected messages. Security protected signaling is based on EPS NAS security context that contains security keys and negotiated algorithms which the UE and network use to cipher and integrity protect NAS messages. Security context is identified by Key Set Identifier (KSI).

In the present disclosure, the term “security protected” means that a protocol data unit (PDU) is either “integrity protected but not ciphered” or “both integrity protected and ciphered”. One way of initiating security protected signaling is that, if a UE has a valid security context then the UE may security protect the very first NAS message (also known as the initial NAS message) of a new NAS signaling connection to the network by integrity protecting the initial NAS message. If the network consequently activates “secure exchange of NAS message”, then the network may reply with a message that is “integrity protected and ciphered.” From that point onward, all messages are to be “integrity protected and ciphered” while all un-ciphered messages are to be discarded. However, the network does not necessarily have the same security context as the UE and hence a new security context may need to be negotiated. Nevertheless, the UE does not know how the network will reply to the initial NAS message.

According to the current version of the protocol, a UE can send several initial NAS messages before receiving any message from the network. One example of such case is a UE that has initiated attach procedure (e.g., having sent an attach request PDU) and needs to deactivate (e.g., by sending a detach request PDU) before receiving from the network a reply to the attach request. Similar examples can be discovered in other EMM procedures as well. Generally, the UE would integrity protect a detach request PDU and, if security protected signaling is activated in the network then new PDUs are to be ciphered as well.

If, in the example above, the network has the same security context as the UE, then the attach request PDU may activate security protected signaling in the network. In such case the network will discard all non-ciphered messages that the UE sends subsequent to the attach request. However, because the UE has not yet received any message from the network, the UE does not know that it should cipher the detach request. Consequently, the network will discard the detach request PDU, which is not ciphered. As a result, the UE and the network may enter different protocol states.

### SUMMARY

The following summary is illustrative only and is not intended to be limiting in any way. That is, the following summary is provided to introduce concepts, highlights, benefits and advantages of the novel and non-obvious techniques described herein. Selected, not all, implementations are further described below in the detailed description. Thus, the following summary is not intended to identify essential features of the claimed subject matter, nor is it intended for use in determining the scope of the claimed subject matter.

An objective of the present disclosure is to introduce solutions that avoid or otherwise address the aforementioned problems. In one example implementation, a method may involve transmitting a first message regarding a first procedure to a mobile network element. The method may also involve transmitting a second message regarding a second procedure to the mobile network element. The method may additionally involve receiving a reply from the mobile network element. The method may further involve, in response to receiving the reply, performing one or more operations that result in the second procedure being continued and the first procedure being discontinued.

In another example implementation, a method may involve receiving a first message from a user equipment (UE) regarding a first procedure. The first message may be security protected. The method may also involve transmitting a reply to the UE responsive to receiving the first message. The method may additionally involve receiving a second message from the UE regarding a second procedure after the transmitting of the reply. The second message may be integrity protected but not ciphered. The method may also involve, in response to the receiving of the second message, deducing that the reply has not reached the UE when the UE transmitted the second message. The method may further involve, in response to the deducing, performing one or more tasks associated with the second procedure.

In one example implementation, an apparatus may include a communication device configured to wirelessly transmit and receive data. The apparatus may also involve a processor coupled to the communication device. The processor may be configured to transmit, via the communication device, a first message regarding a first procedure to a mobile network element. The processor may be also configured to transmit, via the communication device, a second message regarding a second procedure to the mobile network element. The processor may be additionally configured to receive, via the communication device, a reply from the mobile network element. The processor may be further configured to, in response to receiving the reply, perform one or more operations that result in the second procedure being continued and the first procedure being discontinued.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example framework in which various implementations in accordance with the present disclosure may be utilized.

FIG. 2 is a simplified block diagram of an example apparatus in accordance with an implementation of the present disclosure.

FIG. 3 is a flowchart of an example process in accordance with an implementation of the present disclosure.

FIG. 4 is a flowchart of an example process in accordance with another implementation of the present disclosure.

### DETAILED DESCRIPTION OF PREFERRED EMBODIMENTS

### Overview

Implementations in accordance with the present disclosure relate to various techniques, methods, schemes and/or solutions pertaining to the handling of registration rejects with respect to user equipment in mobile communications. According to the present disclosure, a number of possible solutions may be implemented separately or jointly. That is, although these possible solutions may be described below separately, two or more of these possible solutions may be implemented in one combination or another.

In view of the aforementioned problems, the present disclosure proposes multiple solutions directed to NAS security and handling of multiple initial NAS messages with respect to a user equipment in mobile communications.

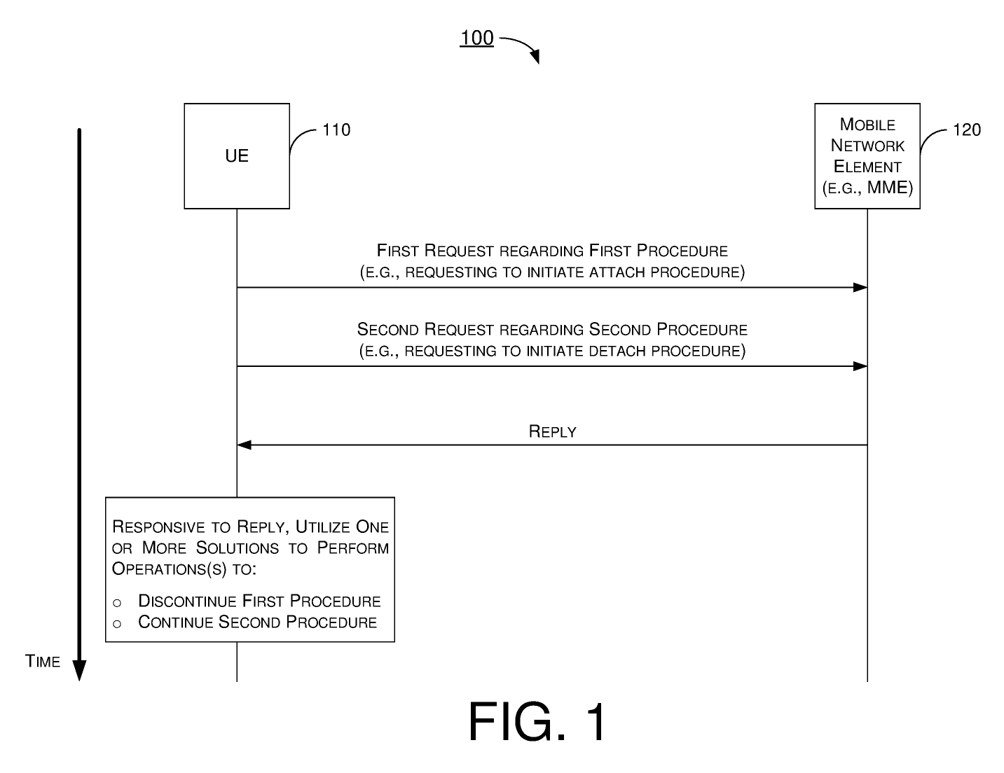

FIG. 1 illustrates an example framework 100 in which various implementations in accordance with the present disclosure may be utilized. In framework 100, a UE 110 and a mobile network element 120 (e.g., an MME) may be part of a mobile network such as, for example, a LTE/E-UTRA network. UE 110 and mobile network element 120 may utilize NAS to establish and/or maintain communication sessions. In framework 100, UE 110 may first transmit a first message (e.g., a first initial NAS message) to mobile network element 120 to request to initiate a first procedure, and then transmit a second message (e.g., a second initial NAS message) to mobile network element 120 to request to initiate a second procedure, as UE 110 may first intended to initiate the first procedure but then decided to initiate the second procedure in lieu of the first procedure such that the first procedure needs to be discontinued, stopped or otherwise aborted. In the context of the example case described above, the first message may be a request to mobile network element 120 to initiate an attach procedure, and the second message may be a request to mobile network element 120 to initiate a detach procedure. UE 110 may receive a reply from mobile network element 120 after both the first message and second message have been transmitted. Based on the reply from mobile network element 120, UE 110 may utilize one or more of the proposed solutions to perform one or more operations so as to continue, restart or otherwise carry out the second procedure with the first procedure being discontinued, stopped or otherwise aborted.

In a first solution according to the present disclosure, UE 110 may indicate a valid KSI in the first message. In an even that the reply (e.g., a first reply message) from mobile network element 120 is security protected, UE 110 may deduce or otherwise determine that the first message has activated security protected signaling and that mobile network element 120 has discarded the second message. Then, UE 110 may restart the second procedure. In the example case, UE 110 may restart detach procedure. In an event that the reply from mobile network element 120 is not security protected, UE 110 may deduce or otherwise determine that mobile network element 120 has received and handled also the second message. Accordingly, UE 110 may continue the second procedure.

In a second solution according to the present disclosure, UE 110 may indicate a valid KSI in the first message. Different from the first solution, however, under the second solution UE 110 may delay the transmission of the second message until UE 110 has received a reply from mobile network element 120. Subsequently, UE 110 may start the second procedure after receiving the reply from mobile network element 120.

In a third solution according to the present disclosure, UE 110 may transmit both first message and second message before receiving any reply, response or message from mobile network element 120. Upon receiving the reply from mobile network element 120, UE 110 may deduce or otherwise determine, based on the type of the reply from mobile network element 120 (e.g., which procedure mobile network element 120 is initiating), whether mobile network element 120 has discarded or handled the second message. Accordingly, UE 110 may either restart the second procedure or continue the second procedure.

In a fourth solution according to the present disclosure, UE 110 may transmit the second message both in a ciphered format and an un-ciphered format. Accordingly, at least one of the security protected format and the unprotected format is processed by mobile network element 120.

In a fifth solution according to the present disclosure, the problem can be solved in the network and, more particularly, by mobile network element 120. In an event that mobile network element 120 receives, from UE 110, the second message which is not ciphered, mobile network element 120 may deduce or otherwise determine that its reply has not reached UE 110. In such cases mobile network element 120 may handle the second message, even if the second message is not ciphered. The deduction may be based on one or more factors such as, for example and not limited to: (1) an uplink (UL) NAS count associated with UE 110, (2) a difference in arrival times of uplink messages from UE 110, and/or (3) the second procedure that UE 110 requests to initiate. That is, the uplink NAS count may indicate that the reply from mobile network element 120 has not reached UE 110 when UE 110 transmitted the second message. Moreover, the difference in the arrival times may indicate that the reply from mobile network element 120 has not reached UE 110 when UE 110 transmitted the second message. Additionally, a determination that UE 110 is initiating the second procedure may indicate that the reply from mobile network element 120 has not reached UE 110 when UE 110 transmitted the second message.

### Example Apparatus

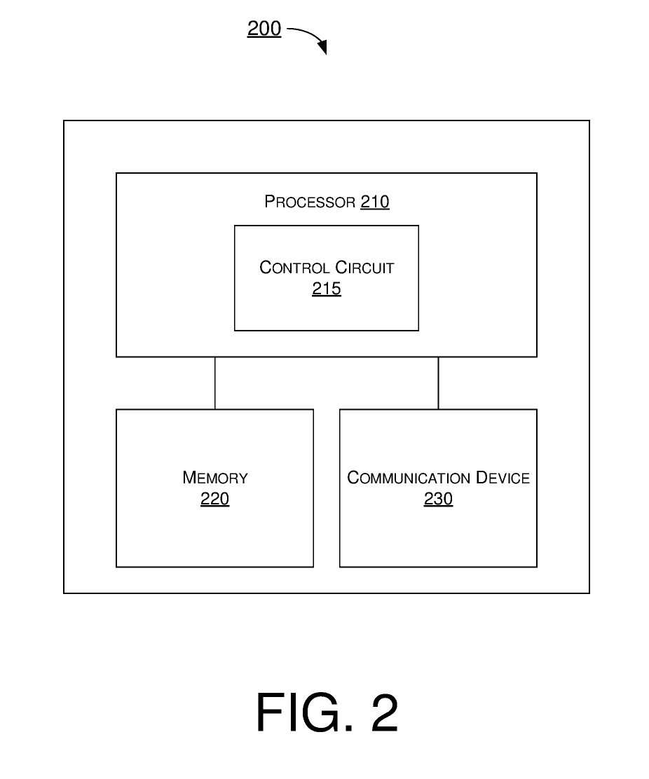

FIG. 2 illustrates an example apparatus 200 in accordance with an implementation of the present disclosure. Apparatus 200 may perform various functions to implement techniques, schemes, methods and solutions described herein. For instance, apparatus 200 may be utilized in framework 100 and may perform the multiple solutions described above, whether individually or in combination, as well as processes 300 and 400 described below. In some implementations, apparatus 200 may be an electronic apparatus which may be a UE such as, for example, a smartphone, a mobile phone or any type of portable or wearable communications apparatus. In some implementations, apparatus 200 may be mobile network element such as a Mobility Management Entity (MME) for example. In some implementations, apparatus 200 may be in the form of one or more integrated-circuit (IC) chip(s). Apparatus 200 may include one or more of those components shown in FIG. 2, such as a processor 210, a memory 220 and a communication device 230. Apparatus 200 may include other component(s) not shown in FIG. 2 which may not be pertinent to the schemes, solutions, techniques and methods in accordance with the present disclosure and, thus, a description thereof is not provided. Processor 210 may be communicatively or otherwise operably coupled to memory 220 and communication device 230. In some implementations, some or all of processor 210, memory 220 and communication device 230 may be integral parts of a single IC chip. Alternatively, processor 210, memory 220 and communication device 230 may be packaged as two or more separate and discrete IC chips.

Memory 220 may be configured to store data as well as one or more sets of processor-executable instructions. Memory 220 may include one or more computer-readable mediums such as a type of read-only memory (ROM) or random-access memory (RAM). For example, memory 220 may include a dynamic RAM (DRAM), static RAM (SRAM), thyristor RAM (T-RAM), zero-capacitor RAM (Z-RAM) or another type of volatile memory. As another example, memory device may include mask ROM, programmable ROM (PROM), erasable programmable ROM (EPROM), electrically-erasable programmable ROM (EEPROM), flash memory, solid-state memory or another type of non-volatile memory.

Communication device 230 may include necessary hardware, firmware and/or software to perform wireless communications (e.g., transmit and receive wireless signals, data and/or messages) with one or more external or remote devices such as, for example and not limited to, one or more eNodeB stations, one or more UE's and one or more MME's. For instance, under the control of processor 210, communication device 230 may engage in wireless communications with an MME to transmit requests to the MME and receive one or more replies from the MME regarding an attach procedure and a detach procedure.

Processor 210 may be a special-purpose computing device designed and configured to perform, execute or otherwise carry out specialized algorithms, software instructions, computations and logics with respect to NAS security and handling of multiple initial NAS messages in accordance with the present disclosure. That is, processor 210 may include specialized hardware (and, optionally, specialized firmware) specifically designed and configured to render or otherwise effect one or more novel solutions to NAS security and handling of multiple initial NAS messages not previously existing or available.

Processor 210 may include at least a control circuit 215. Control circuit 215 may include electronic components, such as one or more transistors, one or more diodes, one or more capacitors, one or more resistors, one or more inductors, one or more memristors, and/or one or more varactors, that are configured and arranged to achieve specific purposes in accordance with the present disclosure.

As apparatus 200 may be implemented as a UE in accordance with some implementations of the present disclosure or as an MME in accordance with some other implementations of the present disclosure, example operations of apparatus 200 as a UE and as an MME are provided below separately.

The following description pertains to the context of apparatus 200 being implemented as a UE in accordance with the present disclosure.

In some implementations, control circuit 215 of processor 210 may be configured to transmit, via communication device 230, a first message regarding a first procedure to a mobile network element. Control circuit 215 may be also configured to transmit, via communication device 230, a second message regarding a second procedure to the mobile network element. Control circuit 215 may be additionally configured to receive, via communication device 230, a reply from the mobile network element. Control circuit 215 may be further configured to perform, in response to receiving the reply, one or more operations that result in the second procedure being continued and the first procedure being discontinued.

In some implementations, in transmitting the first message and the second message to the mobile network element, control circuit 215 may be configured to transmit, via communication device 230, a first NAS message and a second NAS message to an MME of a LTE network. In some implementations, in transmitting the first message to the mobile network element, control circuit 215 may be configured to transmit, via communication device 230, the first NAS message to the MME to request to initiate an attach procedure. In some implementations, in transmitting the second message to the mobile network element, control circuit 215 may be configured to transmit, via communication device 230, the second NAS message to the MME to request to initiate a detach procedure.

In some implementations, the first message may indicate a valid KSI. Correspondingly, in performing the one or more operations, control circuit 215 may be configured to perform a number of operations. For instance, control circuit 215 may determine that the mobile network element has initiated the first procedure and discarded the second message as indicated by the reply from the mobile network element being security protected. Moreover, control circuit 215 may transmit, via communication device 230, a third request which is security protected. The third request may request the MME to initiate the second procedure and discontinue the first procedure.

In some implementations, the first message may indicate a valid KSI. Correspondingly, in performing the one or more operations, control circuit 215 may be configured to perform a number of operations. For instance, control circuit 215 may determine that the mobile network element has initiated the second procedure as indicated by the reply from the mobile network element not being security protected. Furthermore, control circuit 215 may continue with the second procedure by executing one or more tasks associated with the second procedure.

In some implementations, in transmitting the second message, control circuit 215 may be configured to delay the transmitting of the second message to the mobile network element until the reply from the mobile network element is received.

In some implementations, in transmitting the first message and the second message to the mobile network element, control circuit 215 may be configured to transmit, via communication device 230, the first message and the second message prior to receiving the reply from the mobile network element. Moreover, in performing of the one or more operations, control circuit 215 may be configured to perform a number of operations. For instance, control circuit may identify a type of the reply and determine which of the first procedure and the second procedure has been initiated by the mobile network element based on the type of the reply. Control circuit 215 may also proceed to restart the second procedure in an event that it is determined that the mobile network element has initiated the first procedure. Control circuit 215 may further proceed to continue the second procedure in an event that it is determined that the mobile network element has initiated the second procedure.

In some implementations, in transmitting the second message to the mobile network element, control circuit 215 may be configured to transmit, via communication device 230, the second message in a ciphered format and an un-ciphered format. The reply from the mobile network element may include a response to either the ciphered format or the un-ciphered format of the second message.

The following description pertains to the context of apparatus 200 being implemented as an MME in accordance with the present disclosure.

In some implementations, control circuit 215 of processor 210 may be configured to receive, via communication device 230, a first message from a UE regarding a first procedure, with the first message being security protected. Control circuit 215 may also be configured to transmit, via communication device 230, a reply to the UE in response to receiving the first message. Control circuit 215 may be configured to receive, via communication device 230 and after transmitting the reply, a second message from the UE regarding a second procedure, with the second message being integrity protected but not ciphered. Control circuit 215 may be additionally configured to deduce, in response to receiving the second message, that the reply has not reached the UE when the UE transmitted the second message. Control circuit 215 may be further configured to perform, in response to the deduction, one or more tasks associated with the second procedure.

In some implementations, in deducing that the reply has not reached the UE when the UE transmitted the second message, control circuit 215 may be configured to determine an uplink NAS count associated with the UE. The uplink NAS count may indicate that the reply has not reached the UE when the UE transmitted the second message.

Alternatively or additionally, in deducing that the reply has not reached the UE when the UE transmitted the second message, control circuit 215 may be configured to determine a difference in arrival times of uplink messages from the UE. The difference in the arrival times may indicate that the reply has not reached the UE when the UE transmitted the second message.

Alternatively or additionally, in deducing that the reply has not reached the UE when the UE transmitted the second message, control circuit 215 may be configured to determine that the UE is initiating the second procedure based on a content of the second message. The determination that the UE is initiating the second procedure may indicate that the reply has not reached the UE when the UE transmitted the second message.

### Example Processes

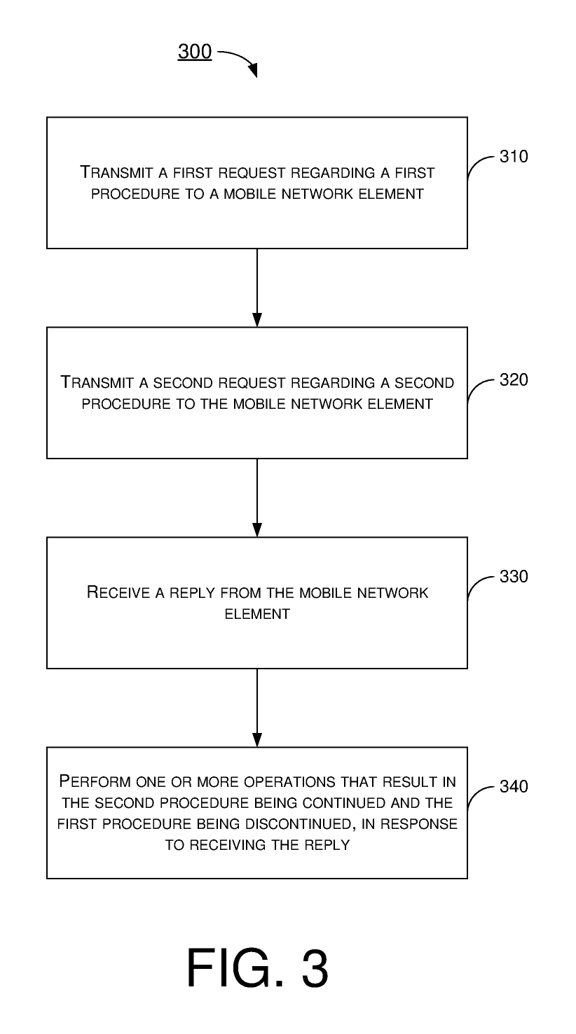

FIG. 3 illustrates an example process 300 in accordance with another implementation of the present disclosure. Process 300 may be an example implementation of one or more of the solutions described above, at least partially. Process 300 may include one or more operations, actions, or functions as represented by one or more blocks such as blocks 310, 320, 330 and 340. Although illustrated as discrete blocks, various blocks of process 300 may be divided into additional blocks, combined into fewer blocks, or eliminated, depending on the desired implementation. The blocks may be performed in the order shown in FIG. 3 or in any other order, depending on the desired implementation. Process 300 may be implemented in framework 100, and may be implemented by apparatus 200 or any variations thereof. Solely for illustrative purpose and without limiting the scope of the present disclosure, process 300 is described below in the context of apparatus 200 being implemented as a UE. Process 300 may begin at 310.

At 310, process 300 may involve apparatus 200 transmitting a first message regarding a first procedure to a mobile network element. Process 300 may proceed from 310 to 320.

At 320, process 300 may involve apparatus 200 transmitting a second message regarding a second procedure to the mobile network element. Process 300 may proceed from 320 to 330.

At 330, process 300 may involve apparatus 200 receiving a reply from the mobile network element. Process 300 may proceed from 330 to 340.

At 340, process 300 may involve apparatus 200 performing, in response to receiving the reply, one or more operations that result in the second procedure being continued and the first procedure being discontinued.

In some implementations, in transmitting the first message and the second message to the mobile network element, process 300 may involve apparatus 200 transmitting a first NAS message and a second NAS message to an MME of a LTE network. In some implementations, in transmitting the first message to the mobile network element, process 300 may involve apparatus 200 transmitting the first NAS message to the MME to request to initiate an attach procedure. In some implementations, in transmitting the second message to the mobile network element, process 300 may involve apparatus 200 transmitting the second NAS message to the MME to request to initiate a detach procedure.

In some implementations, the first message may indicate a valid KSI. Correspondingly, in performing the one or more operations, process 300 may involve apparatus 200 determining that the mobile network element has initiated the first procedure and discarded the second message as indicated by the reply from the mobile network element being security protected. Moreover, process 300 may involve apparatus 200 transmitting a third request which is security protected, the third request requesting to initiate the second procedure and discontinue the first procedure.

In some implementations, the first message may indicate a valid KSI. Correspondingly, in performing the one or more operations, process 300 may involve apparatus 200 determining that the mobile network element has initiated the second procedure as indicated by the reply from the mobile network element not being security protected. Additionally, process 300 may involve apparatus 200 continuing with the second procedure by executing one or more tasks associated with the second procedure.

In some implementations, in transmitting the second message, process 300 may involve apparatus 200 delaying the transmitting of the second message to the mobile network element until the reply from the mobile network element is received.

In some implementations, in transmitting the first message and the second message to the mobile network element, process 300 may involve apparatus 200 transmitting the first message and the second message prior to receiving the reply from the mobile network element. Correspondingly, in performing the one or more operations, process 300 may involve apparatus 200 identifying a type of the reply and determining which of the first procedure and the second procedure has been initiated by the mobile network element based on the type of the reply. Moreover, process 300 may involve apparatus 200 proceeding to restart the second procedure in an event that it is determined that the mobile network element has initiated the first procedure. Furthermore, process 300 may involve apparatus 200 proceeding to continue the second procedure in an event that it is determined that the mobile network element has initiated the second procedure.

In some implementations, in transmitting the second message to the mobile network element, process 300 may involve apparatus 200 transmitting the second message in a ciphered format and an un-ciphered format. The reply from the mobile network element may be a response to either the ciphered format or the un-ciphered format of the second message.

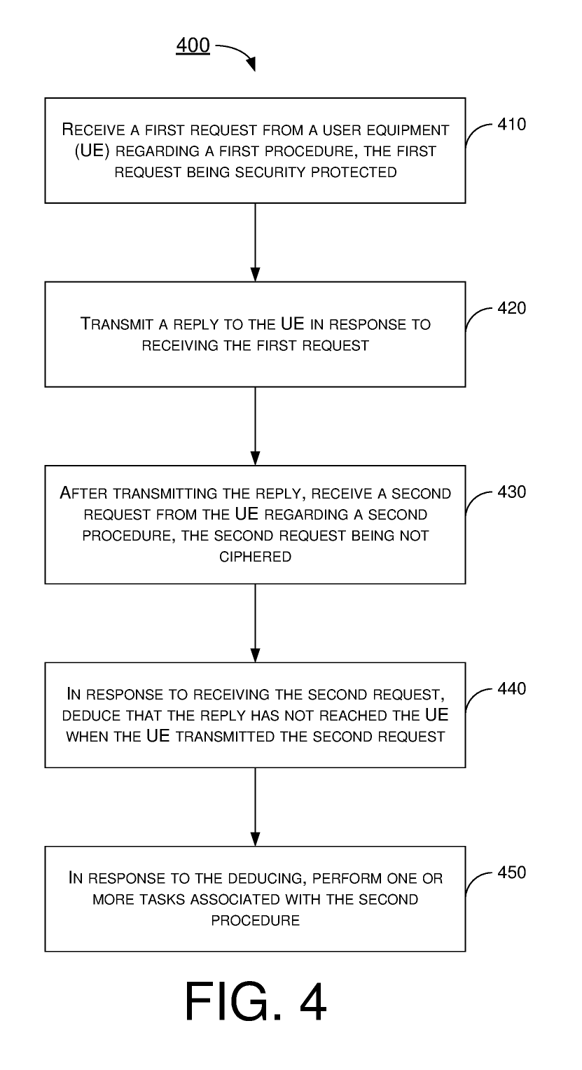

FIG. 4 illustrates an example process 400 in accordance with yet another implementation of the present disclosure. Process 400 may be an example implementation of one or more of the solutions described above, at least partially. Process 400 may include one or more operations, actions, or functions as represented by one or more blocks such as blocks 410, 420, 430, 440 and 450. Although illustrated as discrete blocks, various blocks of process 400 may be divided into additional blocks, combined into fewer blocks, or eliminated, depending on the desired implementation. The blocks may be performed in the order shown in FIG. 4 or in any other order, depending on the desired implementation. Process 400 may be implemented in framework 100, and may be implemented by apparatus 200 or any variations thereof. Solely for illustrative purpose and without limiting the scope of the present disclosure, process 400 is described below in the context of apparatus 200 implemented as a mobile network element, such as an MME for example. Process 400 may begin at 410.

At 410, process 400 may involve apparatus 200 receiving a first message from a UE regarding a first procedure. The first message may be security protected. Process 400 may proceed from 410 to 420.

At 420, process 400 may involve apparatus 200 transmitting a reply to the UE responsive to receiving the first message. Process 400 may proceed from 420 to 430.

At 430, process 400 may involve apparatus 200 receiving, after the transmitting of the reply, a second message from the UE regarding a second procedure. The second message may be integrity protected but not ciphered. Process 400 may proceed from 430 to 440.

At 440, process 400 may involve apparatus 200 deducing, in response to receiving the second message, that the reply has not reached the UE when the UE transmitted the second message. Process 400 may proceed from 440 to 450.

At 450, process 400 may involve apparatus 200 performing, in response to the deducing, one or more tasks associated with the second procedure.

In some implementations, in deducing that the reply has not reached the UE when the UE transmitted the second message, process 400 may involve apparatus 200 determining an uplink NAS count associated with the UE. The uplink NAS count may indicate that the reply has not reached the UE when the UE transmitted the second message.

In some implementations, in deducing that the reply has not reached the UE when the UE transmitted the second message, process 400 may involve apparatus 200 determining a difference in arrival times of uplink messages from the UE. The difference in the arrival times may indicate that the reply has not reached the UE when the UE transmitted the second message.

In some implementations, in deducing that the reply has not reached the UE when the UE transmitted the second message, process 400 may involve apparatus 200 determining that the UE is initiating the second procedure based on a content of the second message. The determination that the UE is initiating the second procedure may indicate that the reply has not reached the UE when the UE transmitted the second message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any multiple and/or singular terms herein, those having skill in the art can translate from the multiple to the singular and/or from the singular to the multiple as is appropriate to the context and/or application. The various singular/multiple permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting a first message regarding a first procedure to a mobile network element;
transmitting a second message regarding a second procedure to the mobile network element;
receiving a reply from the mobile network element; and
responsive to receiving the reply, performing one or more operations that result in the second procedure being continued and the first procedure being discontinued.

2. The method of claim 1, wherein the transmitting of the first message and the second message to the mobile network element comprises transmitting a first Non-Access Stratum (NAS) message and a second NAS message to a Mobility Management Entity (MME) of a Long Term Evolution (LTE) network.

3. The method of claim 2, wherein the transmitting of the first message to the mobile network element comprises transmitting the first NAS message to the MME to request to initiate an attach procedure, and wherein the transmitting of the second message to the mobile network element comprises transmitting the second NAS message to the MME to request to initiate a detach procedure.

4. The method of claim 1, wherein the first message indicates a valid Key Set Identifier (KSI), and wherein the performing of the one or more operations comprises:
determining that the mobile network element has initiated the first procedure and discarded the second message as indicated by the reply from the mobile network element being security protected; and
transmitting a third request which is security protected, the third request requesting to initiate the second procedure and discontinue the first procedure.

5. The method of claim 1, wherein the first message indicates a valid Key Set Identifier (KSI), and wherein the performing of the one or more operations comprises:
determining that the mobile network element has initiated the second procedure as indicated by the reply from the mobile network element not being security protected; and
continuing with the second procedure by executing one or more tasks associated with the second procedure.

6. The method of claim 1, wherein the transmitting of the second message comprises delaying the transmitting of the second message to the mobile network element until the reply from the mobile network element is received.

7. The method of claim 1, wherein the transmitting of the first message and the second message to the mobile network element comprises transmitting the first message and the second message prior to receiving the reply from the mobile network element, and wherein the performing of the one or more operations comprises:
identifying a type of the reply;
determining which of the first procedure and the second procedure has been initiated by the mobile network element based on the type of the reply;
proceeding to restart the second procedure in an event that it is determined that the mobile network element has initiated the first procedure; and
proceeding to continue the second procedure in an event that it is determined that the mobile network element has initiated the second procedure.

8. The method of claim 1, wherein the transmitting of the second message to the mobile network element comprises:
transmitting the second message in a ciphered format and an un-ciphered format,
wherein the receiving of the reply from the mobile network element comprises receiving the reply from the mobile network element as a response to either the ciphered format or the un-ciphered format of the second message.

9. A method, comprising:
receiving a first message from a user equipment (UE) regarding a first procedure, the first message being security protected;
transmitting a reply to the UE responsive to receiving the first message;
after the transmitting of the reply, receiving a second message from the UE regarding a second procedure, the second message being not ciphered;
responsive to the receiving of the second message, deducing that the reply has not reached the UE when the UE transmitted the second message; and
responsive to the deducing, performing one or more tasks associated with the second procedure.

10. The method of claim 9, wherein the deducing that the reply has not reached the UE when the UE transmitted the second message comprises determining an uplink Non-Access Stratum (NAS) count associated with the UE, and wherein the uplink NAS count indicates that the reply has not reached the UE when the UE transmitted the second message.

11. The method of claim 9, wherein the deducing that the reply has not reached the UE when the UE transmitted the second message comprises determining a difference in arrival times of uplink messages from the UE, and wherein the difference in the arrival times indicates that the reply has not reached the UE when the UE transmitted the second message.

12. The method of claim 9, wherein the deducing that the reply has not reached the UE when the UE transmitted the second message comprises determining that the UE is initiating the second procedure based on a content of the second message, and wherein the determining that the UE is initiating the second procedure indicates that the reply has not reached the UE when the UE transmitted the second message.

13. An apparatus, comprising:
a communication device configured to wirelessly transmit and receive data; and
a processor coupled to the communication device, the processor configured to perform operations comprising:
transmitting, via the communication device, a first message regarding a first procedure to a mobile network element;
transmitting, via the communication device, a second message regarding a second procedure to the mobile network element;
receiving, via the communication device, a reply from the mobile network element; and
responsive to receiving the reply, performing one or more operations that result in the second procedure being continued and the first procedure being discontinued.

14. The apparatus of claim 13, wherein, in transmitting the first message and the second message to the mobile network element, the processor is configured to transmit, via the communication device, a first Non-Access Stratum (NAS) message and a second NAS message to a Mobility Management Entity (MME) of a Long Term Evolution (LTE) network.

15. The apparatus of claim 14, wherein, in transmitting the first message to the mobile network element, the processor is configured to transmit, via the communication device, the first NAS message to the MME to request to initiate an attach procedure, and wherein, in transmitting the second message to the mobile network element, the processor is configured to transmit, via the communication device, the second NAS message to the MME to request to initiate a detach procedure.

16. The apparatus of claim 13, wherein the first message indicates a valid Key Set Identifier (KSI), and wherein, in performing the one or more operations, the processor is configured to perform operations comprising:
determining that the mobile network element has initiated the first procedure and discarded the second message as indicated by the reply from the mobile network element being security protected; and
transmitting, via the communication device, a third request which is security protected, the third request requesting to initiate the second procedure and discontinue the first procedure.

17. The apparatus of claim 13, wherein the first message indicates a valid Key Set Identifier (KSI), and wherein, in performing the one or more operations, the processor is configured to perform operations comprising:
determining that the mobile network element has initiated the second procedure as indicated by the reply from the mobile network element not being security protected; and
continuing with the second procedure by executing one or more tasks associated with the second procedure.

18. The apparatus of claim 13, wherein, in transmitting the second message, the processor is configured to delay the transmitting of the second message to the mobile network element until the reply from the mobile network element is received.

19. The apparatus of claim 13, wherein, in transmitting the first message and the second message to the mobile network element, the processor is configured to transmit, via the communication device, the first message and the second message prior to receiving the reply from the mobile network element, and wherein, in performing of the one or more operations, the processor is configured to perform operations comprising:
identifying a type of the reply;
determining which of the first procedure and the second procedure has been initiated by the mobile network element based on the type of the reply;
proceeding to restart the second procedure in an event that it is determined that the mobile network element has initiated the first procedure; and
proceeding to continue the second procedure in an event that it is determined that the mobile network element has initiated the second procedure.

20. The apparatus of claim 13, wherein, in transmitting the second message to the mobile network element, the processor is configured to perform operations comprising:
transmitting, via the communication device, the second message in a ciphered format and an un-ciphered format,
wherein the reply from the mobile network element comprises a response to either the ciphered format or the un-ciphered format of the second message.
